(19) United States
(12) Patent Application Publication
(10) Pub. No.: US 2009/0116166 A1
(43) Pub. Date: May 7, 2009

(54) APPARATUS AND METHOD FOR GENERATING ATMOSPHERIC-PRESSURE PLASMA

(75) Inventors: Masashi Matsumori, Osaka (JP); Shigeki Nakatsuka, Kyoto (JP); Takanori Ichiki, Tokyo (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/299,859

(22) PCT Filed: Apr. 6, 2007
(86) PCT No.: PCT/JP2007/057767

§ 371 Date: Dec. 15, 2008

(30) Foreign Application Priority Data
May 8, 2006 (JP) 2006-129193
Sep. 26, 2006 (JP) 2006-260602

(51) Int. Cl. H01T 23/00; H05H 1/24

(52) U.S. Cl. 361/230; 204/164

(57) ABSTRACT

An apparatus for generating atmospheric-pressure plasma includes: a substrate; an antenna arranged on the substrate; a discharge tube arranged in the vicinity of the antenna; a high-frequency power supply for supplying VHF band high-frequency power to the antenna; and a matching circuit for receiving a high frequency from the high-frequency power supply and adjusting a reflection wave. In this apparatus for generating atmospheric-pressure plasma, a phase circuit is connected between the matching circuit and the antenna, and the phase circuit has a circuit constant setting such that a position of a maximum value of a current amplitude of a standing wave or a position of a minimum value of a voltage amplitude of the standing wave is in the vicinity of the antenna. This configuration can efficiently generate plasma and reduce the size of the apparatus.

### TECHNICAL FIELD

The present invention relates to an apparatus and a method for generating atmospheric-pressure plasma in which high-frequency power is supplied to an antenna arranged on a substrate and a gas is introduced into a discharge tube arranged in the vicinity of the antenna to generate inductively coupled plasma under atmospheric pressure.

### BACKGROUND ART

Conventionally, vacuum plasma generators and atmospheric-pressure plasma generators were too large to be employed in a system which was incorporated into robots and operated therein. However, in recent years, such a compact apparatus for generating atmospheric-pressure plasma has been suggested which generates inductively coupled plasma under atmospheric pressure to provide it as a plasma jet (for example, see Patent Document 1).

As shown in FIG. 20, this apparatus for generating atmospheric-pressure plasma employs a plasma chip 40 which includes a substrate 41, a wavelike micro-antenna 42 arranged on the substrate 41, and a discharge tube 43 arranged in the vicinity of the micro-antenna 42. This apparatus allows gas supply means 44 to supply a gas through one end of the discharge tube 43 and a high-frequency power supply 45 (see FIG. 21) to supply high-frequency power at a VHF band (30 to 500 MHz) to the micro-antenna 42. This allows for generating low-power atmospheric-pressure plasma P with high stability in a micro-space inside the discharge tube 43, and providing it as a micro-plasma jet.

Furthermore, as shown in FIG. 21, a matching circuit 46 is connected between the micro-antenna 42 and the high-frequency power supply 45. The matching circuit 46 serves to adjust reflection waves from the micro-antenna 42 to prevent the input power to the micro-antenna 42 from being lowered due to the reflection waves, thereby efficiently generating plasma with stability. In the example illustrated in FIG. 21, the matching circuit 46 is made up of a LOAD-side reactance element 47 which is connected in parallel to the high-frequency power supply 45 and a TUNE-side reactance element 48 which is connected between one end thereof and the micro-antenna 42. In the example illustrated in FIG. 21, the reactance elements 47 and 48 each are made up of a variable capacitor, but they may also be made up of a fixed or variable capacitor or inductor. Note that in FIG. 21, L is the inductance component of the micro-antenna 42 and R is the resistance component of the circuit.

There is also known a method employed in a plasma processing apparatus in which a gas is introduced into a vacuum process chamber and a high frequency is applied between a pair of opposed electrodes to generate plasma, thereby etching a workpiece placed on one electrode. In the method, the selectivity of the etching is ensured as follows, or more specifically, it is ensured as follows that for an insulating film of oxide film which is predominantly etched with ions, polysilicon which is etched with both radicals and ions is etched selectively. That is, to reduce the ion energy that significantly contributes to the etching of the insulating film, the position at which the minimum amplitude of a standing wave produced in a high-frequency supply path is aligned with the position of the electrodes so that the high-frequency bias applied to the electrodes is reduced (for example, see Patent Document 2).

Note that in Patent Document 2, the frequency used is 13.56 MHz in the RF frequency band, and as the method for aligning the minimum amplitude position of the standing wave with the electrode position, a method is disclosed in which the length of a cable between a high-frequency tuner and the electrode is adjusted. This method raises a problem that the cable may take a length of a few meters to adjust the amplitude of the standing wave.

Furthermore, Patent Document 2 mentioned above also describes the configuration with a phase adjuster inserted in the high-frequency supply path. However, this configuration also raises a problem that the phase adjuster is interposed between the high-frequency power supply and the high-frequency tuner to adjust the amount of phase of the phase adjuster, causing the adjustment to be made with difficulty.

[Patent Document 1] Specification of Japanese Patent No.

[Patent Document 2] Japanese Patent Application Laid-Open No. 2002-373883

### DISCLOSURE OF THE INVENTION

### Problems to be Solved by the Invention

In Patent Document 1 mentioned above, disclosed are such a principle and the contents of experiments for generating a low-power plasma jet of a high-concentration plasma with stability. That is, to generate stable low-power plasma in a micro-space under atmospheric-pressure, power is efficiently supplied to the plasma by the inductive coupling scheme. This scheme makes use of a VHF band that allows for capturing part of ions and electrons in a micro-discharge tube as well as a dielectric magnetic field that is produced by a current flowing through the antenna. However, Patent Document 1 has not yet provided a sufficient technique for more efficiently generating plasma at lower power consumption and realizing improved compactness.

For example, Patent Document 1 mentioned above has disclosed the contents of an experiment that was carried out at 50 W or less. However, to realize further applications such as processing or surface reforming, it is necessary to further improve the plasma concentration of the micro-plasma jet generated using the same power.

On the other hand, the technique disclosed in Patent Document 2 mentioned above basically relates to a plasma processing apparatus which employs a parallel flat plates scheme. In addition, the technique uses a frequency of the RF frequency band and aims to reduce the high-frequency bias applied to the electrodes in order to enhance the selectivity of processing, thus never suggesting any means for solving the aforementioned problems. Also the method in which the length of the cable is adjusted to thereby adjust the minimum amplitude position of a standing wave is described. However, the method raises a problem that even when a VHF band high frequency is used, the cable is a few tens of centimeters in length, and thus it is not possible to reduce the size of the apparatus enough to accommodate it in a box, for example, with a side of about 10 cm. Furthermore, even when the phase adjuster is used, it is interposed between the high-frequency power supply and the high-frequency tuner, and thus the adjustment is made with difficulty as described above.

Furthermore, when micro-plasma is generated using the plasma chip 40 disclosed in Patent Document 1 mentioned above, the micro-antenna 42 will increase in temperature. When the plasma is generated for a long duration, the micro-antenna 42 will be lifted from the substrate 41 thereby degrading heat dissipation, possibly causing the patterned portion of the micro-antenna 42 to be burnt. In addition, an increase in the temperature of the micro-antenna 42 will cause an increase in resistance, resulting in loss of balance in the matching circuit. This in turn greatly changes the reflection wave from the micro-antenna 42 to reduce the power to be supplied to the micro-antenna 42, thereby reducing the strength of the plasma.

Furthermore, in the configuration provided with the matching circuit 46, the reactance element such as an inductance element or a capacitance element which constitutes the circuit will generate heat, which in turn will change the circuit constants of the matching circuit 46. It is thus impossible to efficiently generate the plasma P with stability.

Furthermore, a large amount of heat is also generated from the trace that connects between the micro-antenna 42 and the matching circuit 46. This will result in a change in the resistance of the trace, thereby causing a change in the circuit constants of the matching circuit 46. It is thus impossible to efficiently generate the plasma P with stability. Note that to prevent the effects of heat generated from the trace, the heat generated from the trace could be dissipated or the trace itself can be shortened. However, such a configuration that meets these methods has not yet been realized.

In this context, in view of the conventional problems mentioned above, the present invention was developed. It is therefore an object of the invention to provide an apparatus for generating atmospheric-pressure plasma in order to generate inductively coupled plasma using VHF band high-frequency power. The apparatus for generating atmospheric-pressure plasma is intended to efficiently generate plasma and reduce the size of the apparatus. It is another object of the invention is to provide a method for generating atmospheric-pressure plasma.

It is also another object to provide an apparatus for generating atmospheric-pressure plasma which can prevent the circuit constants from being changed due to heat generated from a reactance element that constitutes a circuit such as the matching circuit, the antenna, and the trace. This is intended to efficiently generate plasma with stability and realize a compact structure.

### Means for Solving the Problems

In order to achieve the objects mentioned above, an apparatus for generating atmospheric-pressure plasma of the present invention includes: a substrate; an antenna arranged on the substrate; a discharge tube arranged in the vicinity of the antenna; a high-frequency power supply for supplying VHF band high-frequency power to the antenna; a matching circuit for receiving a high frequency from the high-frequency power supply and adjusting a reflection wave; and a phase circuit connected between the matching circuit and the antenna. In the apparatus, the phase circuit has a circuit constant setting such that a position of a maximum value of a current amplitude of a standing wave is in the vicinity of the micro-antenna or a position of a minimum value of a voltage amplitude of the standing wave is in the vicinity of the micro-antenna.

Furthermore, a method for generating atmospheric-pressure plasma according to the present invention includes the steps of: supplying a VHF band high frequency to an antenna arranged on a substrate and introducing a gas into a discharge tube arranged in the vicinity of the antenna to generate plasma; allowing a matching circuit to adjust a reflection wave entering a high-frequency power supply to around 0; and adjusting a circuit constant of a phase circuit interposed between the matching circuit and the antenna so that a position of a maximum value of a current amplitude of a standing wave is in the vicinity of the antenna or a position of a minimum value of a voltage amplitude of the standing wave is in the vicinity of the antenna.

According to the configuration of the present invention described above, a current flowing through the antenna contributes greatly to the generation of the plasma. Thus, the phase circuit is interposed between the matching circuit and the antenna, so that the phase circuit serves to position the maximum value of the current amplitude of the standing wave in the vicinity of the antenna. This makes it possible to efficiently supply the input power as a current flowing through the antenna, thereby generating plasma efficiently. Furthermore, since at a high frequency, the voltage standing wave and the current standing wave are 180 degrees out of phase, the same effect can be obtained by positioning the minimum value of the voltage amplitude of the standing wave in the vicinity of the antenna.

The phase circuit can be formed of either one of or both a first reactance element disposed between one terminal of the matching circuit and one terminal of the antenna and a current-carrying path connecting therebetween, and either one of or both a second reactance element disposed between the other terminal of the matching circuit and the other terminal of the antenna and a current-carrying path connecting therebetween. That is, either one of or both the reactance elements and the current-carrying path having a predetermined length can be used to adjust the amplitude position of a standing wave. Use of the reactance elements makes it possible to provide a more compact configuration. However, the current-carrying path having a predetermined length can be also designed to provide a compact arrangement, thereby providing the same effects.

The first reactance element and the second reactance element each can be formed of at least one of a fixed inductor, a variable inductor, a fixed capacitor, and a variable capacitor.

Furthermore, the elements of the matching circuit which are connected in series to the first and second reactance elements of the phase circuit, respectively, can be coupled together to form those reactance elements of one reactance element.

Furthermore, provision of the elements constituting the matching circuit and the phase circuit on the substrate makes it possible to reduce the overall size of the apparatus for generating atmospheric-pressure plasma. Additionally, if the Radio Law is met or the safety hazards of the apparatus are cleared, it will be possible to develop such an application as the operator holds it by the hand for use.

Furthermore, the antenna is not limited to one which is patterned on a substrate but may also be configured to have a three-dimensional coil arranged on the substrate.

Furthermore, the apparatus for generating atmospheric-pressure plasma according to the present invention includes: an antenna; a discharge tube arranged in the vicinity of the antenna and having an end into which a gas is supplied; a high-frequency power supply for supplying high-frequency power to the antenna; a matching circuit interposed between the antenna and the high-frequency power supply to adjust a reflection wave from the antenna; and a phase circuit interposed between the antenna and the matching circuit for adjusting the phase in the vicinity of the antenna. In the apparatus, the antenna is disposed on a substrate, and one or more other substrates are stacked on the substrate to form a stacked substrate. Furthermore, a planar reactance element constituting the matching circuit or the phase circuit is arranged on the stacked substrate or is sandwiched between the substrates of the stacked substrate. Furthermore, the apparatus can be configured in the same manner even in the absence of the phase circuit.

According to this configuration, the reactance elements constituting the matching circuit and the phase circuit are formed in a planar shape to be arranged on the stacked substrate or sandwiched between the substrates of the stacked substrate. This allows the heat generated from the reactance elements to be dissipated to outside through the substrates smoothly and effectively. This makes it possible to prevent the circuit constants of the matching circuit and the phase circuit from being changed due to an increase in the temperature of the reactance elements. This in turn allows for efficiently supplying the high-frequency power to the antenna with stability, thereby efficiently producing the plasma with stability. Furthermore, since the planar reactance element is sandwiched between substrates of the stacked substrate, a compact configuration can be realized.

Furthermore, a three-dimensional reactance element, constituting the matching circuit or the matching circuit and the phase circuit, is arranged on the substrate having the antenna disposed thereon. This three-dimensional reactance element is covered with the substrate in contact therewith and included within the stacked substrate. This allows the heat generated from the three-dimensional reactance elements to be effectively dissipated through the substrate having them disposed thereon and the substrate covering them. It is thus possible to efficiently produce plasma with stability in the same manner.

Furthermore, the antenna, the discharge tube, both the matching circuit and the phase circuit or only the matching circuit, the trace connecting therebetween, and a coaxial connector for connecting with a power supply coaxial cable may be included in the stacked substrate. This will allow for providing an apparatus for generating atmospheric-pressure plasma, which has a compact configuration with the outer appearance of its main portion consisting of only the block-shaped stacked substrate. Only a tube for supplying a gas and the coaxial cable for supplying high-frequency power need to be connected to this configuration, thereby making it possible to perform plasma processing. It is thus possible to efficiently facilitate various types of plasma processing with stability in a simplified manner.

Furthermore, the planar antenna is sandwiched between substrates in the stacked substrate, and the planar reactance elements are disposed on the substrates sandwiching the antenna. Sandwiching the antenna between the substrates allows for effectively dissipating the heat generated from the antenna and efficiently supplying high-frequency power to the antenna with stability, thereby making it possible to efficiently produce plasma with stability. Additionally, since the substrates are also shared to dispose the planar reactance elements thereon, it is possible to reduce the area and the quantity of substrates, thereby providing a more compact configuration.

Furthermore, the discharge tube and the antenna wound multiple times around it are sandwiched between substrates of the stacked substrate, and the planar reactance element is disposed on the substrate for sandwiching the discharge tube and the antenna. This makes it possible to provide the same effects even when the antenna wound around the discharge tube is employed.

Furthermore, if the reactance element mentioned above is an inductance element which is made of a conductor arranged in a spiral fashion on the substrate, the inductance element easily generates heat. However, the inductance element can be formed in a planar shape and sandwiched between substrates of the stacked substrate, thereby allowing the heat generated to be dissipated to outside through the substrates smoothly and effectively. This will provide particularly significant effects.

Furthermore, the trace provided on a substrate is sandwiched between substrates of the stacked substrate. This allows for effectively dissipating the heat generated from the trace through the substrates. It is also possible to prevent the circuit constants of the matching circuit and the phase circuit from being changed and thus efficiently produce plasma with stability.

Furthermore, the connections of the traces formed on the substrates of the stacked substrate to be connected to each other are arranged so as to overlap each other and are then connected to each other with the substrates in intimate contact with each other being coupled to each other. This allows for providing electrical circuit connections only by the substrates constituting the stacked substrate being coupled to each other while they are in intimate contact with each other. It is thus possible to realize an inexpensive compact configuration which is simplified in configuration and can be easily assembled.

Furthermore, the substrates can be formed of a material selected from the group consisting of alumina, sapphire, aluminum nitride, silicon nitride, boron nitride, and silicon carbide, thereby providing a high thermal conductivity to the substrates and thus a high heat dissipation capability.

Furthermore, the aforementioned apparatus for generating atmospheric-pressure plasma can be mounted in the movable head of a robot system which can displace in the X, Y, and Z directions. This allows for providing a compact plasma processing apparatus which has an extremely enhanced general versatility.

### BRIEF DESCRIPTION OF THE DRAWINGS

FIG. 1 is a perspective view illustrating the configuration of the main portion of an apparatus for generating atmospheric-pressure plasma according to a first embodiment of the present invention.

FIG. 2 is a schematic circuit block diagram of the first embodiment.

FIG. 3 is a specific circuit block diagram of the first embodiment.

FIG. 4 is an explanatory view illustrating a standing wave.

FIG. 5 is a graph illustrating the voltage amplitude of each example experiment of the first embodiment.

FIG. 6 is another specific circuit block diagram of the first embodiment.

FIG. 7 is still another specific circuit block diagram of the first embodiment.

FIG. 8 is a perspective view illustrating the configuration of the main portion of a modified example of the first embodiment.

FIG. 9 is a perspective view illustrating the configuration of an apparatus for generating atmospheric-pressure plasma according to a second embodiment of the present invention.

FIG. 10 is a front view illustrating the second embodiment.

FIG. 11 is a top view illustrating a first substrate of the second embodiment.

FIGS. 12A to 12B are views illustrating a second substrate of the second embodiment, FIG. 12A being a top view and FIG. 12B being a bottom view.

FIG. 13 is a perspective view illustrating the configuration of an apparatus for generating atmospheric-pressure plasma according to a third embodiment of the present invention.

FIG. 14 is a perspective view illustrating a fourth substrate of the third embodiment when viewed from below.

FIG. 15 is a front view illustrating the configuration of an apparatus for generating atmospheric-pressure plasma according to a fourth embodiment of the present invention.

FIG. 16 is a top view illustrating a first substrate of the fourth embodiment.

FIG. 17 is a perspective view illustrating a discharge tube and an antenna of the fourth embodiment.

FIG. 18 is a perspective view illustrating a second substrate of the fourth embodiment when viewed from below.

FIG. 19 is a perspective view illustrating how to measure the intensity of plasma radiation.

FIG. 20 is a perspective view illustrating the configuration of the main portion of an apparatus for generating atmospheric-pressure plasma according to a conventional example.

FIG. 21 is a circuit diagram illustrating an example configuration of a matching circuit.

### BEST MODE FOR CARRYING OUT THE INVENTION

A description will now be made to the embodiments of the present invention.

### First Embodiment

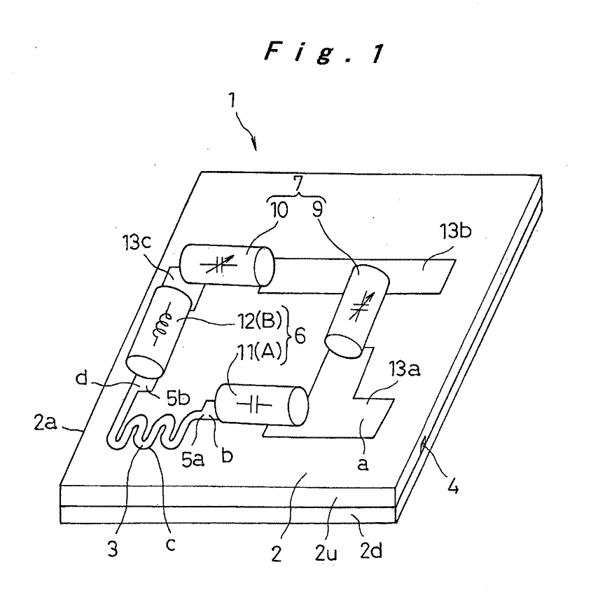

To begin with, with reference to FIGS. 1 to 8, a description will be made to an apparatus for generating atmospheric-pressure plasma according to a first embodiment of the present invention.

As shown in FIG. 1, in an apparatus 1 of the present embodiment for generating atmospheric-pressure plasma, a multiple-wave shaped antenna 3 is formed on a substrate 2 made of alumina, and a discharge tube 4 is provided in the vicinity of the antenna 3. In the example illustrated, the substrate 2 is made up of an upper substrate 2u, which has the antenna 3 on its upper surface and a groove for forming the discharge tube 4 on its lower surface, and a lower substrate 2d affixed to the lower surface of the upper substrate 2u. Note that the discharge tube 4 of the present invention refers to a component which forms such a tubular discharge space and is thus not necessarily limited to a pipe or tube which has an inner circumferential surface and an outer circumferential surface. Furthermore, the antenna 3 is located in the proximity of a side 2a of the substrate 2 having one opening end of the discharge tube 4 through which a jet of plasma is provided.

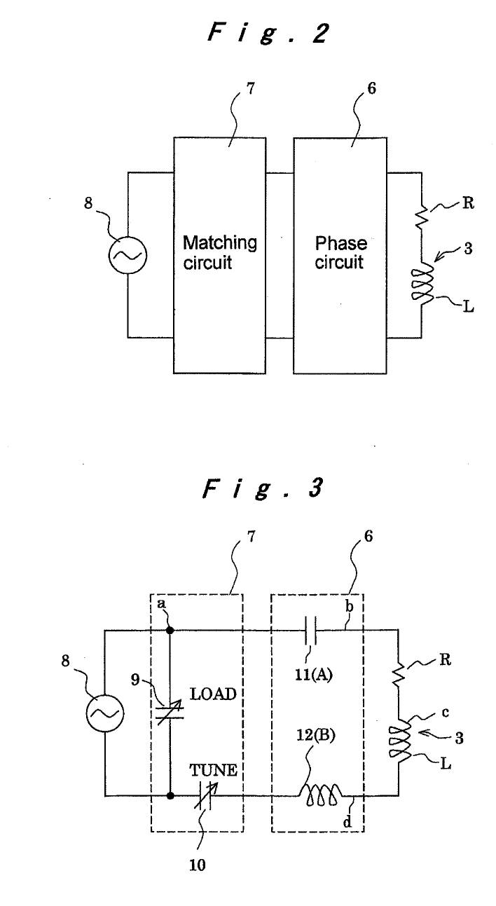

As shown in FIG. 2, to input high-frequency power to the antenna 3, its pair of terminals 5a and 5b are connected with a high-frequency power supply 8 via a phase circuit 6 and a matching circuit 7. The high-frequency power supply 8 outputs VHF band high frequencies, for example, frequencies of about 30 to 500 MHz at a power of about 20 to 100 W. Furthermore, in this specific example, the reactance component L of the antenna 3 is 30 nH and the internal resistance R of the circuit is 400 mΩ.

The matching circuit 7 allows the input of a reflection wave to the high-frequency power supply 8 to be adjusted to around 0, the reflection wave occurring when the high-frequency power is supplied to the antenna 3. More specifically, as shown in FIG. 3, the adjustment can be made using a variable capacitor 9 connected as a LOAD element in parallel to the high-frequency power supply 8 and a variable capacitor 10 connected as a TUNE element in series between the high-frequency power supply 8 and the micro-antenna 3. As a matter of course, the matching circuit 7 may also be made up of a combination of a capacitor and an inductor.

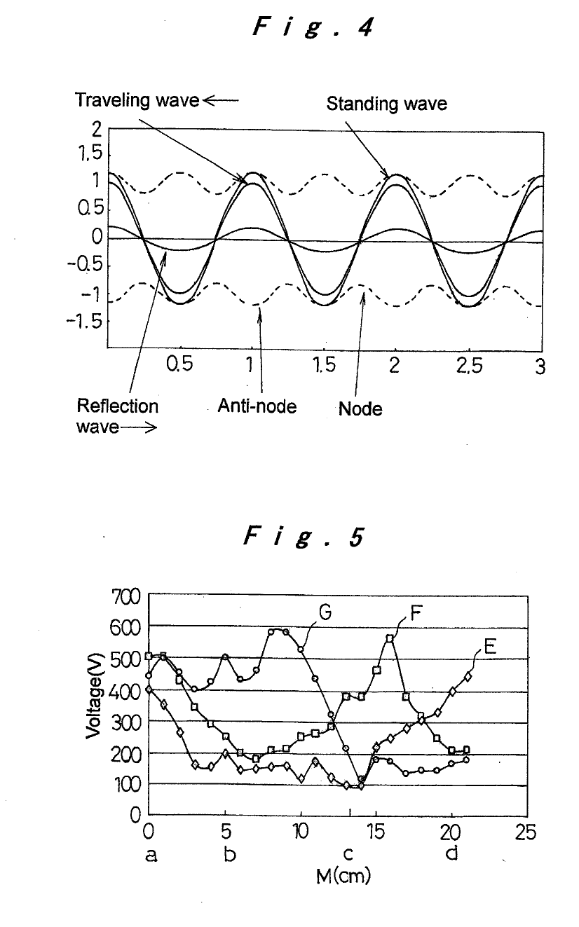

As shown in FIG. 4, the phase circuit 6 is to adjust the positions of the anti-node (or a portion having the maximum amplitude value) and the node (or a portion having the minimum amplitude value) of the amplitude of a standing wave. The standing wave is formed in a high frequency supply path by the traveling wave supplied from the high-frequency power supply 8 toward the antenna 3 being combined with the reflection wave from the antenna 3. As shown in FIG. 3, in the specific example of the present embodiment, a first reactance element (Element A) is formed of a fixed capacitor 11 which is connected between the LOAD-side terminal of the matching circuit 7 and one end of the micro-antenna 3. A second reactance element (Element B) is formed of a fixed inductor 12 which is connected between the TUNE-side terminal of the matching circuit 7 and the other end of the micro-antenna 3. These first reactance element (Element A) and the second reactance element (Element B) each can be formed of at least one of a fixed inductor, a variable inductor, a fixed capacitor, and a variable capacitor.

Furthermore, to actually configure the circuit, the LOAD element 9 and the TUNE element 10 of the matching circuit 7 are formed of a variable element, whereas the first reactance element (Element A) and the second reactance element (Element B) of the phase circuit 6 are formed of a fixed reactance element. With the LOAD element 9 and the TUNE element 10 of the matching circuit 7 being temporarily set to an adequate setting, the first reactance element (Element A) and the second reactance element (Element B) of the phase circuit 6 are selected so that the anti-node of the current amplitude of the standing wave is positioned in the vicinity of the micro-antenna 3. After that, the LOAD element 9 and the TUNE element 10 of the matching circuit 7 are varied for fine adjustments, thereby preferably facilitating the adjustment.

In the present embodiment, as shown in FIG. 1, the LOAD element 9 and the TUNE element 10 of the matching circuit 7 and the first reactance element (Element A) and the second reactance element (Element B) of the phase circuit 6 are mounted on the substrate 2. The elements are connected to each other through patterned circuits 13a, 13b, and 13c which are formed on the substrate 2.

In the aforementioned configuration, a gas is introduced into the discharge tube 4 through the other end opening on the side opposite to the side 2a of the substrate 2, and VHF band high-frequency power is supplied between the patterned circuits 13a and 13b on the substrate 2 from the high-frequency power supply 8. Since the phase circuit 6 has made an adjustment such that the maximum value of the current amplitude of the standing wave is positioned in the vicinity of the antenna 3, this allows the input power from the high-frequency power supply 8 to be supplied efficiently as a current flowing through the antenna 3. It is thus possible to generate plasma efficiently. Furthermore, the antenna 3, the phase circuit 6, and the matching circuit 7 are arranged on the substrate 2. This makes it possible to provide a compact apparatus, for example, such a compact apparatus that is reduced in size enough to be accommodated in a box with a side of about 10 cm.

Here, with reference to FIG. 5 and Table 1, a description will be made to an example experiment with the phase circuit 6.

TABLE 1

| | | | Voltage | Radiation |
|---|---|---|---|---|
| Example | | | amplitude at | intensity |
| experiment | Element A | Element B | point c (V) | (arb. unit) |
| E | 10 pF | 100 nH | 100 V | 55000 |
| F | 22 pF | 54 nH | 380 V | Not ignited |
| G | 120 pF | 9.9 nH | 110 V | 60000 |

As shown in Table 1, the element A capacitor and the element B inductor were set as combinations of 10 pF and 100 nH (Example experiment E), 22 pF and 54 nH (Example experiment F), and 120 pF and 9.9 nH (Example experiment G). Then, on each of the combinations, voltage amplitude measurements were made at various distances from point “a” (reference point) in FIGS. 1 and 3. Graphs E, F, and G of FIG. 5 show the voltage amplitude at each position for Example experiments E, F, and G, respectively. Furthermore, point “a,” point “b,” point “c,” and point “d” indicate the positions shown in FIGS. 1 and 3, where point “c” shows a position in the vicinity of the micro-antenna 3. As shown in Table 1, the voltage amplitude at point “c” was 100 V for Example experiment E and 110 V for Example experiment G, whereas it was as high as 380 V for Example experiment F.

Furthermore, in each of Example experiments E, F, and G mentioned above, high-frequency power of 50 W at 100 MHz was supplied and an argon gas of 0.7 slm was introduced into the discharge tube. Under these conditions, measurements were made on the intensity of plasma radiation. As a result, Example experiments E and G showed as high radiation intensities as 55000 and 60000 arb.unit, respectively. However, no ignition was observed in Example experiment F. It is thus shown that the voltage amplitude of the standing wave in the vicinity of the antenna 3 can be adjusted to the minimum value, thereby generating a jet of plasma of a high concentration even using low power.

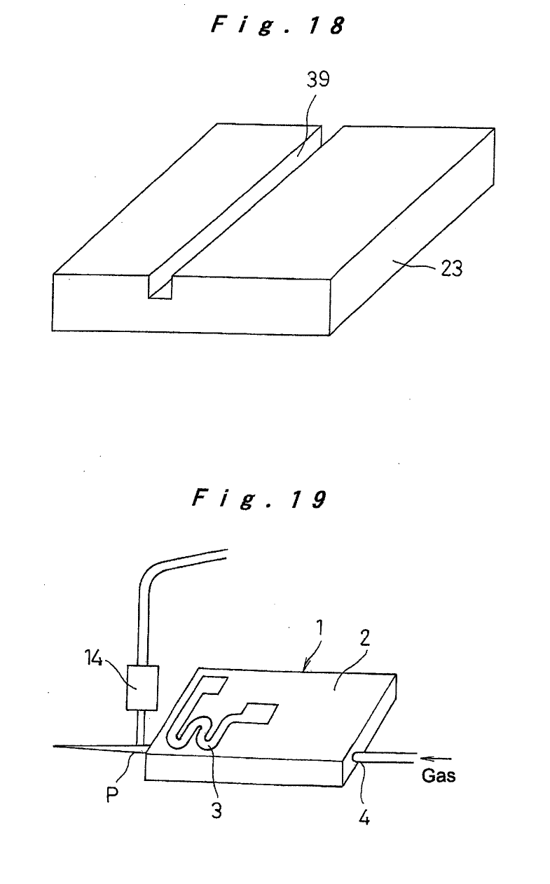

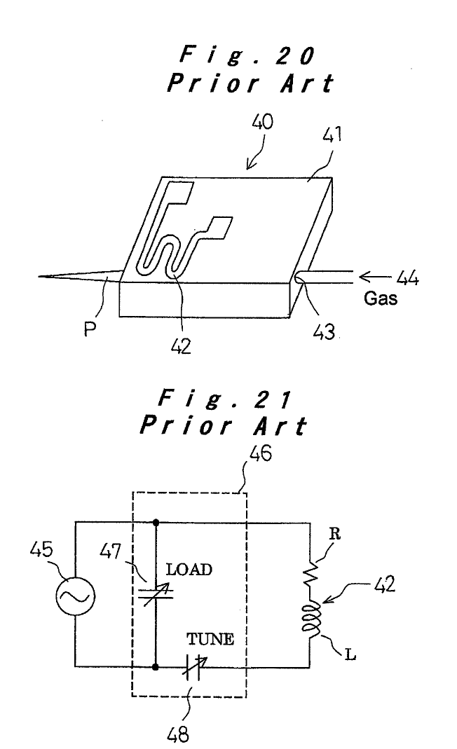

Note that as shown in FIG. 19, in the measurements of the intensity of atmospheric-pressure plasma radiation, the radiation intensity of the plasma P generated was measured using a spectroscope (not shown) via an optical fiber 14.

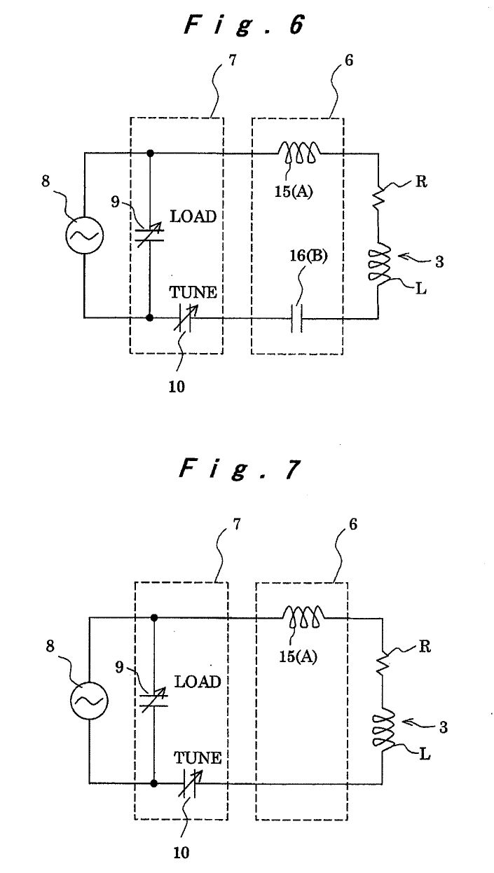

In the examples shown in FIGS. 1 to 5, the fixed capacitor 11 was used as the first reactance element (Element A), whereas the fixed inductor 12 was used as the second reactance element (Element B). However, as shown in FIG. 6, a fixed inductor 15 may also be used as the first reactance element (Element A) and a fixed capacitor 16 as the second reactance element (Element B). Furthermore, the TUNE element of the matching circuit 7 may be made of the variable capacitor 10 and the second reactance element (Element B) may be made of a capacitor or an element of the same type. In this case, as shown in FIG. 7, the TUNE element 10 of the matching circuit 7 may be designed to function as the second reactance element (Element B). Furthermore, the second reactance element (Element B) may be an inductor. Even in this case, if the TUNE element 10 (variable capacitor) of the matching circuit 7 has a wide variable range, its function may be replaced with the TUNE element 10. Furthermore, although not illustrated, the first reactance element (Element A) and the second reactance element (Element B) may also be designed to provide the same function as that of the current-carrying path which was devised to have such a length as to make a compact configuration. It is also possible to employ this current-carrying path and the reactance element at the same time.

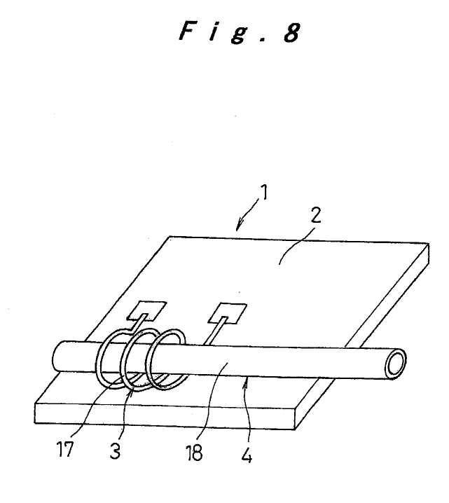

Furthermore, in the example configuration of FIG. 1, the antenna 3 shown that was provided on the substrate 2 was patterned on the upper surface of the substrate 2. However, as shown in FIG. 8, it is also acceptable to provide an antenna 17 of a three-dimensional coil on the substrate 2 and insert the coil 17 into a discharge tube 18 made of a glass tube or the like.

The apparatus 1 for generating atmospheric-pressure plasma according to the first embodiment can provide a compact configuration because the antenna 3 is provided on the substrate 2. Additionally, the phase circuit 6 is interposed between the matching circuit 7 and the antenna 3, and then is adjusted so that the current amplitude or the voltage amplitude of the standing wave occurring in the vicinity of the antenna 3 takes on the maximum value or the minimum value. When compared with the case of adjusting the cable length, this allows for providing a significantly compact configuration by which the antenna 3 can produce generally the maximum plasma. Accordingly, even when plasma is generated using the same input power, it is possible to produce the plasma nearly at its maximum concentration and radiation intensity, thereby developing applications, for example, for processing and surface reforming. Furthermore, the provision of the matching circuit 7 and the phase circuit 6 on the substrate 2 makes it possible to reduce the size of the apparatus 1 for generating atmospheric-pressure plasma and incorporate it into a robot for operation. Additionally, if the Radio Law is met or the safety hazards of the apparatus are cleared, it will be possible to develop such an application as the operator holds it by the hand for use.

Furthermore, the apparatus 1 for generating atmospheric-pressure plasma is applicable to various analyzers in the chemistry and biochemistry fields. In particular, it is also preferably applicable, for example, to the micro chemical analysis systems (μTAS: Micro Total Analysis System) which include the combinations of high-speed separation techniques of a trace amount of substance by gas chromatography or micro-capillary electrophoresis with laser induced fluorescence detections, electrochemical measurements using micro-electrodes, ICP-OES (Inductively Coupled Plasma Optical Emission Spectroscopy), or ICP mass spectrograph. Furthermore, the apparatus can be utilized in various fields, for example, for cutting by melting a local portion of a workpiece such as a micro-chip used for micro-devices; processing and surface treatment such as etching, deposition of thin film, cleaning, hydrophilic processing, or repellent processing; or high-temperature processing of hazardous substances.

### Second Embodiment

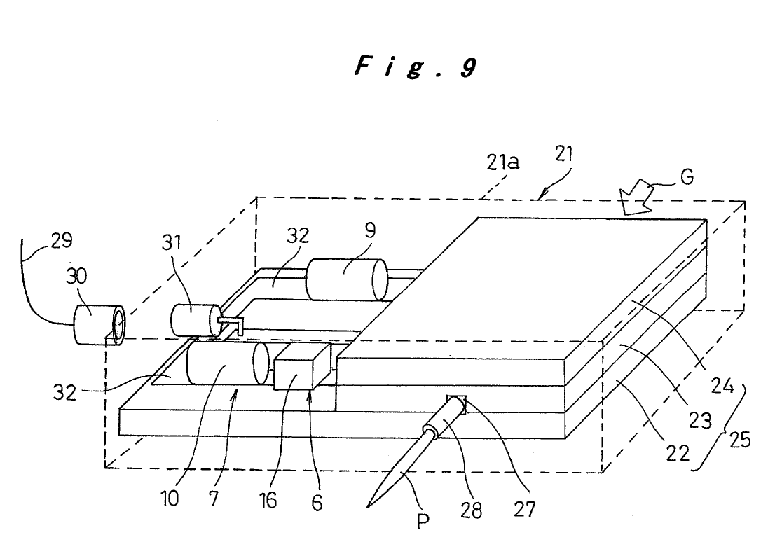

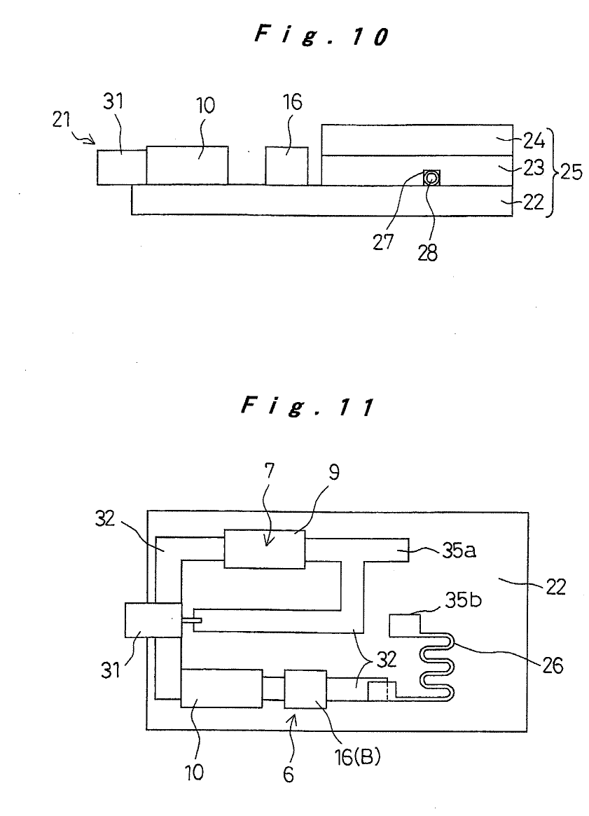

With reference to FIGS. 9 to 12B, a description will now be made to an apparatus for generating atmospheric-pressure plasma according to a second embodiment of the present invention. Note that in the descriptions of the embodiments below, their different points will be mainly explained with the same components being indicated with the same reference symbols without any further explanation of them.

As shown in FIGS. 9 to 11, an apparatus 21 for generating atmospheric-pressure plasma according to the present embodiment includes a first substrate 22 made of alumina, a multiple-wave shaped antenna 26 arranged on the first substrate 22, a second substrate 23 arranged on one half region of the first substrate 22 where the antenna 26 is provided, and a third substrate 24 arranged on the second substrate 23. The first substrate 22, the second substrate 23, and the third substrate 24 are integrally coupled to each other using various fasteners such as screws or adhesives while they are in intimate contact with each other, thereby forming a stacked substrate 25. This configuration allows the antenna 26 to be accommodated in the stacked substrate 25 while being sandwiched between the first and second substrates 22 and 23. Each of the substrates that constitute the stacked substrate 25 may be preferably formed of a material of high thermal conductivity, such as alumina, sapphire, aluminum nitride, silicon nitride, boron nitride, and silicon carbide.

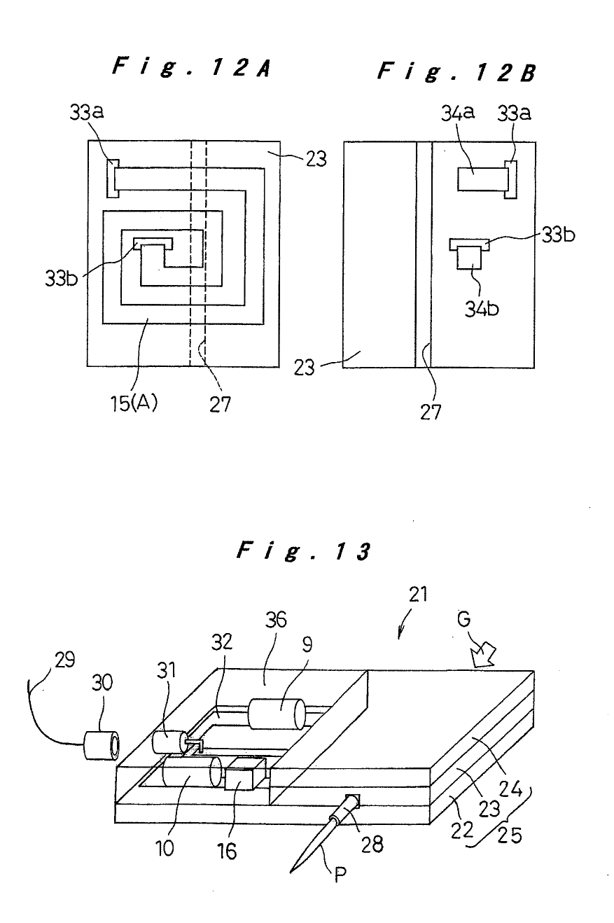

As shown in FIGS. 12A and 12B, a storage groove 27 is formed on the lower surface of the second substrate 23, i.e., at a position on a surface in contact with the first substrate 22 opposite to the center axis line of the antenna 26. The storage groove 27 stores a dielectric discharge tube 28, and preferably, an adhesive or filler of a high thermal conductivity is filled in the gap between the storage groove 27 and the discharge tube 28. Then, as shown in FIG. 9, a gas G is supplied through one end of the discharge tube 28, and for example, high-frequency power of about 20 to 100 W is supplied at a VHF band frequency of 100 MHz from a high-frequency power supply (not shown) to the antenna 26, thereby allowing the plasma P to be delivered from the other end of the discharge tube 28.

At the center of the other end of the other half region of the first substrate 22 where the antenna 26 is not located, a substrate-side connector 31 is provided which is connected to the high-frequency power supply (not shown) and to which a cable-side connector 30 at a tip of an coaxial cable 29 for supplying high-frequency power is connected. The connector 31 and the antenna 26 are connected to each other via a trace 32 formed on the first substrate 22. Halfway through the trace 32, the reactance elements are provided which form the matching circuit 7 and the phase circuit 6 as shown in FIG. 6. The antenna 26 and the trace 32 are preferably formed by stamping or cutting of a thin metal plate or metal foil which has a low specific resistance. For example, this metal may be copper (specific resistance of 17.2 nΩm (at 20° C.), temperature coefficient of 0.004/° C.), silver (specific resistance of 16.2 nΩm (at 20° C.), temperature coefficient of 0.004/° C.), gold (specific resistance of 24.0 nΩm (at 20° C.), temperature coefficient of 0.0034/° C.), or aluminum (specific resistance of 28.2 nΩm (at 20° C.), temperature coefficient of 0.004/° C.). Among these metals, copper is the most preferable one, with its thickness being twice or more or three times or less the depth from the surface on which the high frequency current flows. For example, in the case of the high frequency current of a frequency of 100 MHz, a thickness about 100 μm is preferable.

In the present embodiment, the storage groove 27 was provided on the second substrate 23. However, it is also acceptable to provide the storage groove 27 on the first substrate 22 to store the discharge tube 28 therein.

In the present embodiment, the matching circuit 7 is made up of the LOAD-side variable capacitor 9 and the TUNE-side variable capacitor 10, both of which are a three-dimensional reactance element. Furthermore, the phase circuit 6 is made up of the inductance element 15 arranged between the LOAD-side variable capacitor 9 and the antenna 26 and the fixed capacitor 16 arranged between the TUNE-side variable capacitor 10 and the antenna 26. The fixed capacitor 16 is a three-dimensional reactance element. However, as shown in FIG. 12A, the inductance element 15 is a spiral conductor disposed in a planar shape on the upper surface of the second substrate 23 that sandwiches the antenna 26, and thus is included in the stacked substrate 25 while being sandwiched with the third substrate 24.

As shown in FIG. 12B, the spiral inductance element 15 has its both ends which extend downwardly through via holes 33a and 33b formed to penetrate the second substrate 23 and electrically connect to connections 34a and 34b which are provided on the lower surface. On the other hand, a connection 35a at an end of the trace 32 connected to the variable capacitor 9 arranged on the first substrate 22 and a connection 35b provided on one end of the antenna 26 are aligned with the connections 34a and 34b so that they overlap with each other when the second substrate 23 is stacked on the first substrate 22. When the first substrate 22 and the second substrate 23 are stacked one on the other in intimate contact with each other, the connections 34a and 35a, and 34b and 35b are electrically connected to each other, respectively.

Note that as indicated in FIG. 9 with broken lines, the apparatus 21 for generating atmospheric-pressure plasma is configured to accommodate the stacked substrate 25 within a case 21a in such a manner that only one end of the discharge tube 28 for supplying the gas G, the other end of the discharge tube 28 for emitting the plasma P therethrough, and an end portion of the connector 31 are exposed to outside.

The apparatus 21 for generating atmospheric-pressure plasma, configured as described above, has the planar antenna 26 sandwiched between the first and second substrates 22 and 23 in the stacked substrate 25. It is thus possible to effectively dissipate heat generated from the antenna 26 and efficiently input the high-frequency power into the antenna 26 with stability, thereby efficiently producing the plasma P with stability.

Furthermore, the planar inductance element 15 made up of a spiral conductor is disposed on the second substrate 23 for sandwiching the antenna 26 and then sandwiched by the third substrate 24. This may cause the inductance element to more easily generate heat when compared with other reactance elements. However, the heat generated from the inductance element 15 can be smoothly dissipated outwardly through the second and third substrates 23 and 24 in an effective manner. It is thus possible to prevent the circuit constants of the matching circuit 7 and the phase circuit 6 from being changed due to an increase in the temperature of the inductance element 15. This in turn makes it possible to stably input the high-frequency power into the antenna 26 with improved efficiency and efficiently produce the plasma with stability. Furthermore, since the planar inductance element 15 is also disposed on the second substrate 23 for sandwiching the antenna 26, it is possible to reduce the area and quantity of the substrates 22 to 24 that constitute the stacked substrate 25, thereby realizing a compact configuration.

Furthermore, the connections 34a and 34b, and 35a and 35b, which are to be connected to each other, respectively, are provided on the first substrate 22 and the second substrate 23 so that they overlap each other. Then, the first and second substrates 22 and 23 are coupled to each other while they are in intimate contact with each other, thereby allowing the connections 34a and 34b, and 35a and 35b to be connected to each other, respectively. This allows for providing electrical circuit connections only by coupling together the substrates 22 through 24 constituting the stacked substrate 25 while they are in intimate contact with each other. It is thus possible to realize an inexpensive compact configuration with a simple structure which can be easily assembled.

Note that in the present embodiment, the third substrate 24 was brought into intimate contact with the inductance element 15. However, without using the third substrate 24, the inductance element 15 may also be provided on the second substrate 23, thereby dissipating heat.

### Third Embodiment

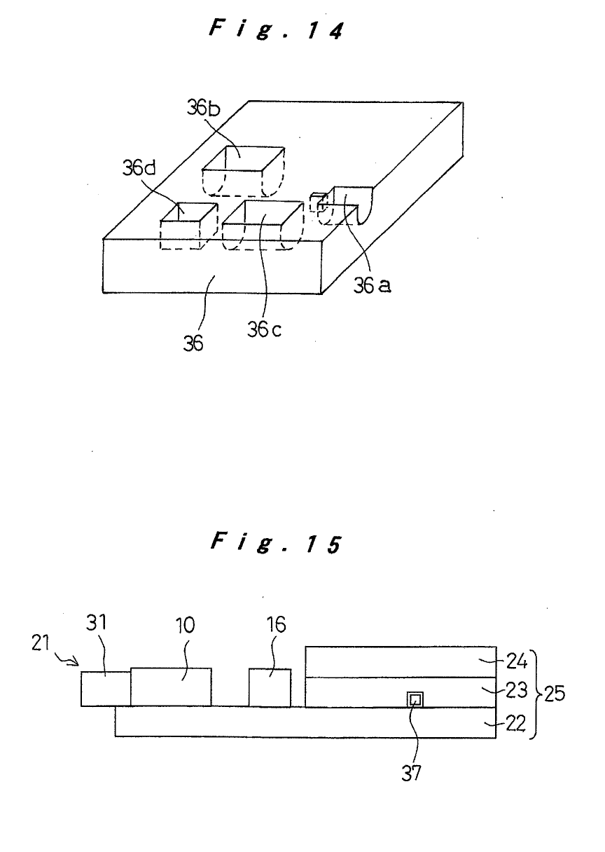

With reference to FIGS. 13 and 14, a description will now be made to an apparatus for generating atmospheric-pressure plasma according to a third embodiment of the present invention.

In the present embodiment, as shown in FIG. 13, a fourth substrate 36 is stacked on a region of the first substrate 22 on which the second and third substrates 23 and 24 are not stacked, i.e., the region of the first substrate 22 on which parts such as three-dimensional reactance elements are disposed. More specifically, the fourth substrate 36 is stacked on the region where the LOAD-side and TUNE-side variable capacitors 9 and 10 of the matching circuit 7, the fixed capacitor 16 of the phase circuit 6, and the connector 31 of the coaxial cable 29 are disposed. As shown in FIG. 14, the fourth substrate 36 has recessed portions 36a to 36d for accommodating the connector 31, the variable capacitors 9 and 10, and the fixed capacitor 16, respectively, and is configured to cover these elements in contact therewith. Furthermore, the trace 32 provided on the first substrate 22 is also sandwiched between the first substrate 22 and the second and fourth substrates 23 and 36.

In this manner, the stacked substrate 25 made up of the first to fourth substrates 22, 23, 24, and 36 includes the antenna 26, the discharge tube 28, the matching circuit 7, the phase circuit 6, the trace 32 connecting therebetween, and the connector 31. The apparatus 21 for generating atmospheric-pressure plasma is thus composed of the single block-shaped stacked substrate 25 which has no element or trace exposed to outside.

According to this configuration, the three-dimensional reactance elements 9, 10, and 16 constituting the matching circuit 7 and the phase circuit 6 are arranged on the first substrate 22 having the antenna 26 disposed thereon. These reactance elements are covered with the fourth substrate 36 in contact therewith and included within the stacked substrate 25. The heat generated from these reactance elements can be also effectively dissipated through the first substrate 22 and the fourth substrate 36, thereby efficiently producing plasma with stability.

Furthermore, the heat generated from the antenna 26, the discharge tube 28, the matching circuit 7, the phase circuit 6, the trace 32, and the connector 31 is smoothly dissipated to outside from the outer surface of the stacked substrate 25 through the first to fourth substrates 22, 23, 24, and 36 that constitute the stacked substrate 25. It is thus ensured to prevent the circuit constants from being changed due to an increase in the temperature of not only the reactance elements constituting the matching circuit 7 and the phase circuit 6 and the antenna 26 but also the connector 31 and the trace 32. This allows for efficiently generating plasma with stability.

Furthermore, the antenna 26, the discharge tube 28, the matching circuit 7, and the phase circuit 6, the trace 32 connecting therebetween, and the connector 31 are included within the stacked substrate 25. It is thus possible to provide the apparatus 21 for generating atmospheric-pressure plasma which has a compact configuration with the outer appearance of its main portion consisting only of the block-shaped stacked substrate 25. Only the tube (not shown) for supplying a gas and the coaxial cable 29 for supplying high-frequency power need to be connected to this configuration, thereby making it possible to perform plasma processing. It is thus possible to efficiently facilitate various types of plasma processing with stability in a simplified manner.

### Fourth Embodiment

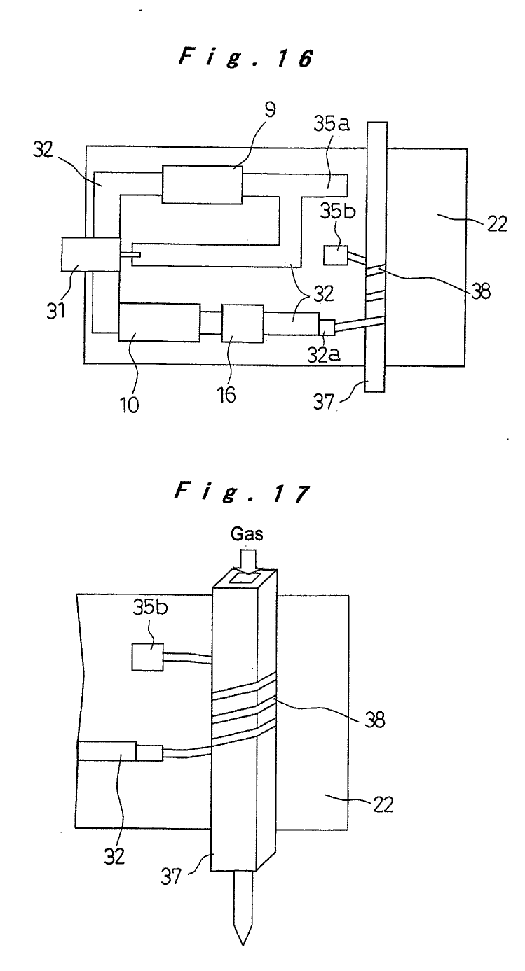

With reference to FIGS. 15 to 18, a description will now be made to an apparatus for generating atmospheric-pressure plasma according to a fourth embodiment of the present invention.

In the second embodiment described above, such an example was shown in which the wavelike flat-shaped antenna 26 is disposed on the first substrate 22 to be sandwiched between the first substrate 22 and the second substrate 23. In the forth embodiment, as shown in FIGS. 15 to 18, a conductor thin strip such as copper foil is wound multiple times in a spiral fashion around a discharge tube 37, which is generally square in cross section, to form the antenna 38. Then, the discharge tube 37 and the antenna 38 are disposed on the first substrate 22, and are sandwiched between it and the second substrate 23. The planar inductance element 15 is disposed on the face of the second substrate 23 opposite to another face confronting the first substrate 22, so that the inductance element 15 is sandwiched between the second substrate 23 and the third substrate 24. This configuration is the same as that of the first embodiment described above.

Both end portions of the antenna 38 are disposed so as to overlap a connection 32a of the trace 32 provided on the first substrate 22 and the connection 35b for the inductance element 15, and are sandwiched by the second substrate 23 in intimate contact therewith, thereby being electrically connected to the trace 32 and the inductance element 15. As shown in FIG. 18, the second substrate 23 has a storage groove 39, which is square in cross section and is formed therein to accommodate the discharge tube 37, having the antenna 38 wound around it, in intimate contact therewith. A filler or an adhesive of a high thermal conductivity is filled, as required, in between the storage groove 39 and the discharge tube 37 having the antenna 38 wound around it. When a filler or an adhesive of a high thermal conductivity is filled in this manner, the discharge tube 37 and the storage groove 39 need not to be square in cross section and thus may be circular in cross section. In the present embodiment, the discharge tube 37 and the storage groove 39 are provided on the second substrate 23. However, the first substrate 22 may be provided with the storage groove 39 to accommodate the discharge tube 37. It is also acceptable that the discharge tube 37 is circular in shape, and the first and second substrates 22 and 23 each are provided with a semicircular storage groove.

According to the present embodiment, the discharge tube 37 and the antenna 38 wound multiple times around it are sandwiched between the first and second substrates 22 and 23 of the stacked substrate 25. The planar inductance element 15 is disposed on the second substrate 23 for sandwiching the discharge tube 37 and the antenna 38. It is thus possible to provide the same effects as those of the first embodiment described above using the antenna 38 wound around the discharge tube 37.

Note that in the embodiments described above, such examples have been shown in which the three first to third substrates 22 to 24 are stacked to form the stacked substrate 25, and the fourth substrate 36 is stacked on the first substrate 22 to form the stacked substrate 25. However, the number of substrates constituting the stacked substrate 25 can be arbitrarily designed depending on the layout of the antennas 26 and 37, the discharge tubes 28 and 37, and each reactance element that constitutes the matching circuit 7 and the phase circuit 6.

In the descriptions of each of the embodiments above, such an example has been explained which has the matching circuit 7 and the phase circuit 6. However, even in the presence of only the matching circuit 7 without the phase circuit 6, the present invention can be applied to a case where the matching circuit 7 has a flat-shaped reactance element, thereby providing the same effects. Furthermore, in the embodiments described above, such an example has been shown in which only the variable capacitors 9 and 10 are used as reactance elements that constitute the matching circuit 7. However, as a matter of course, such a configuration can also be employed which uses a fixed capacitor or an inductance element. In such a case, particularly, the inductance element easily generates heat and is thus preferably sandwiched between substrates serving as a flat-shaped inductance element to be thereby included in the stacked substrate.

Furthermore, the aforementioned apparatus 21 for generating atmospheric-pressure plasma can be mounted in the movable head of a robot system which can displace in the X, Y, and Z directions. This allows for providing a compact plasma processing apparatus which has an extremely enhanced general versatility.

Furthermore, in each of the embodiments described above, only such an example has been explained which provides high-frequency power at a VHF band (30 to 500 MHZ). However, the invention is not limited thereto. The invention is also applicable to a microwave band (500 MHZ or greater), and the second to fourth embodiments can be applied to an RF band (13 to 30 MHZ).

### INDUSTRIAL APPLICABILITY

As described above, according to the present invention, the phase circuit is interposed between the matching circuit and the micro-antenna, and the phase circuit is adjusted so that the current amplitude of a standing wave takes on the maximum value or the voltage amplitude of the standing wave takes on the minimum value in the vicinity of the micro-antenna. This allows for efficiently generating a micro-plasma jet at low-power and enhancing the concentration and radiation intensity of the plasma produced at the same input power nearly to the maximum possible limit. It is thus possible to preferably not only apply the invention to the micro-chemical analysis using micro-capillary electrophoresis but also provide high processing capabilities for developing applications such as various types of processing and surface treatment. Furthermore, the reactance elements of the matching circuit and the phase circuit are formed in a planar shape and are sandwiched between the substrates of the stacked substrate, thereby allowing the heat from the reactance elements to be effectively dissipated to outside. This makes it possible to prevent the circuit constants from being changed due to an increase in the temperature of the reactance elements, and efficiently input the high-frequency power into the antenna with stability, thereby efficiently producing the plasma with stability. It is also possible to realize a compact configuration, and thus preferably use the invention for various types of apparatus for generating atmospheric-pressure plasma, particularly, for a compact apparatus for generating atmospheric-pressure plasma to be incorporated into various types systems.

1. An apparatus for generating atmospheric-pressure plasma comprising:
a substrate;
an antenna arranged on the substrate;
a discharge tube arranged in the vicinity of the antenna;
a high-frequency power supply for supplying VHF band high-frequency power to the antenna;
a matching circuit for receiving a high frequency from the high-frequency power supply and adjusting a reflection wave; and
a phase circuit connected between the matching circuit and the antenna,
the phase circuit having a circuit constant setting such that a position of a maximum value of a current amplitude of a standing wave is in the vicinity of the antenna or a position of a minimum value of a voltage amplitude of the standing wave is in the vicinity of the antenna.

2. An apparatus for generating atmospheric-pressure plasma according to claim 1, wherein the phase circuit is formed of
either one of or both a first reactance element disposed between one terminal of the matching circuit and one terminal of the antenna and a current-carrying path connecting therebetween, and
either one of or both a second reactance element disposed between the other terminal of the matching circuit and the other terminal of the antenna and a current-carrying path connecting therebetween.

3. An apparatus for generating atmospheric-pressure plasma comprising:
an antenna;
a discharge tube arranged in the vicinity of the antenna and having an end into which a gas is supplied;
a high-frequency power supply for supplying high-frequency power to the antenna;
a matching circuit interposed between the antenna and the high-frequency power supply to adjust a reflection wave from the antenna; and
a phase circuit interposed between the antenna and the matching circuit for adjusting a phase in the vicinity of the antenna,
the antenna being disposed on a substrate, one or more other substrates being stacked on the substrate to form a stacked substrate, and a planar reactance element which constitutes the matching circuit or the phase circuit being arranged on the stacked substrate or sandwiched between the substrates of the stacked substrate.

4. An apparatus for generating atmospheric-pressure plasma comprising:
an antenna;
a discharge tube arranged in the vicinity of the antenna and having an end into which a gas is supplied;
a high-frequency power supply for supplying high-frequency power to the antenna; and
a matching circuit interposed between the antenna and the high-frequency power supply to adjust a reflection wave from the antenna,
the antenna being disposed on a substrate, one or more other substrates being stacked on the substrate to form a stacked substrate, and a planar reactance element which constitutes the matching circuit being arranged on the stacked substrate or sandwiched between the substrates of the stacked substrate.

5. The apparatus for generating atmospheric-pressure plasma according to claim 3, wherein a three-dimensional reactance element, constituting the matching circuit or the matching circuit and the phase circuit, is arranged on the substrate having the antenna disposed thereon; and
these three-dimensional reactance element is covered with the substrate in contact therewith and included within the stacked substrate.

6. The apparatus for generating atmospheric-pressure plasma according to claim 3, wherein the antenna, the discharge tube, both the matching circuit and the phase circuit or only the matching circuit, a trace connecting therebetween, and a coaxial connector for connecting with a power supply coaxial cable are included in the stacked substrate.

7. A method for generating atmospheric-pressure plasma comprising the steps of:
supplying a VHF band high frequency to an antenna arranged on a substrate and introducing a gas into a discharge tube arranged in the vicinity of the antenna to generate plasma;
allowing a matching circuit to adjust a reflection wave entering a high-frequency power supply to around 0; and
adjusting a circuit constant of a phase circuit interposed between the matching circuit and the antenna so that a position of a maximum value of a current amplitude of a standing wave is in the vicinity of the antenna.

8. A method for generating atmospheric-pressure plasma comprising the steps of:
supplying a VHF band high frequency to an antenna arranged on a substrate and introducing a gas into a discharge tube arranged in the vicinity of the antenna to generate plasma;
allowing a matching circuit to adjust a reflection wave entering a high-frequency power supply to around 0; and
adjusting a circuit constant of a phase circuit interposed between the matching circuit and the antenna so that a position of a minimum value of a voltage amplitude of a standing wave is in the vicinity of the antenna.

9. The apparatus for generating atmospheric-pressure plasma according to claim 4, wherein a three-dimensional reactance element, constituting the matching circuit or the matching circuit and the phase circuit, is arranged on the substrate having the antenna disposed thereon; and
these three-dimensional reactance element is covered with the substrate in contact therewith and included within the stacked substrate.

10. The apparatus for generating atmospheric-pressure plasma according to claim 4, wherein the antenna, the discharge tube, both the matching circuit and the phase circuit or only the matching circuit, a trace connecting therebetween, and a coaxial connector for connecting with a power supply coaxial cable are included in the stacked substrate.
